(19) United States
(12) Patent Application Publication
(10) Pub. No.: US 2019/0272310 A1
(43) Pub. Date: Sep. 5, 2019

(54) COMPUTATIONAL DEVICE, COMPUTATIONAL METHOD, AND COMPUTER PROGRAM

(71) Applicant: Sony Semiconductor Solutions Corporation, Kanagawa (JP)

(72) Inventor: Hiroaki Sakaguchi, Kanagawa (JP)

(73) Assignee: Sony Semiconductor Solutions Corporation, Kanagawa (JP)

(21) Appl. No.: 16/344,953

(22) PCT Filed: Oct. 23, 2017
(86) PCT No.: PCT/JP2017/038104

§ 371 Date: Apr. 25, 2019

(30) Foreign Application Priority Data
Dec. 1, 2016 (JP) 2016-233845

(51) Int. Cl. G06F 17/17; G06F 7/548

(52) U.S. Cl. CPC G06F 17/17; G06F 7/548

(57) ABSTRACT

[Object] To provide a computational device capable of computing an accurate approximation of the hyperbolic tangent function with a simple configuration.

[Solution] There is provided a computational device including: a computational unit configured to approximate a hyperbolic tangent function, which takes a hyperbolic tangent of an input x and outputs an output y, with a broken line having a slope of 2 to an nth power (where n=−2, −1, 0) in which the slope changes on a boundary at which a value of the input x becomes ±2 to a kth power (where k=−1, 0, 1). The input x and the output y are values in floating-point format. The computational unit performs operations in multiple segments having different slopes of the broken line with a single computational expression.

### TECHNICAL FIELD

The present disclosure relates to a computational device, a computational method, and a computer program.

### BACKGROUND ART

In the field of neural networks, the hyperbolic tangent function (tanh) is used extensively. The hyperbolic tangent function is a function expressed by the following formula, and is used to determine whether or not a predetermined threshold value has been exceeded, for example.

$$tanh ( x ) = \frac{{e}^{x} - {e}^{- x}}{{e}^{x} + {e}^{- x}} \qquad [ Math . 1 ]$$

The hyperbolic tangent function is a nonlinear function, and to simplify the computation of the hyperbolic tangent function, technologies that approximate the hyperbolic tangent function with a linear expression or the like are disclosed in Patent Literature 1 to 3, for example.

### CITATION LIST

### Patent Literature

Patent Literature 1: JP H06-215021A

Patent Literature 2: JP 2005-509371T

Patent Literature 3: JP 2012-513724T

### DISCLOSURE OF INVENTION

### Technical Problem

As one attempts to approximate the hyperbolic tangent function accurately, the circuit scale becomes larger. In cases such as processing hyperbolic tangent function circuits in parallel as the activation function of a neural network, since the circuit scale becomes large, a large degree of parallelization cannot be set. On the other hand, if the hyperbolic tangent function is approximated roughly, the error becomes larger, and if used as the activation function of a neural network, the errors accumulate and the recognition accuracy falls.

Accordingly, the present disclosure proposes a novel and improved computational device, computational method, and computer program capable of computing an accurate approximation of the hyperbolic tangent function with a simple configuration.

### Solution to Problem

According to the present disclosure, there is provided a computational device including: a computational unit configured to approximate a hyperbolic tangent function, which takes a hyperbolic tangent of an input x and outputs an output y, with a broken line having a slope of 2 to an nth power (where n=−2, −1, 0) in which the slope changes on a boundary at which a value of the input x becomes ±2 to a kth power (where k=−1, 0, 1). The input x and the output y are values in floating-point format. The computational unit performs operations in multiple segments having different slopes of the broken line with a single computational expression.

In addition, according to the present disclosure, there is provided a computational method including, by a processor: approximating a hyperbolic tangent function, which takes a hyperbolic tangent of an input x and outputs an output y, with a broken line having a slope of 2 to an nth power (where n=−2, −1, 0) with boundaries at a value of 2 to a kth power (where k=−1, 0, 1). The input x and the output y are values in floating-point format. The processor performs operations in multiple segments having different slopes of the broken line with a single computational expression.

In addition, according to the present disclosure, there is provided a computer program causing a computer to approximate a hyperbolic tangent function, which takes a hyperbolic tangent of an input x and outputs an output y, with a broken line having a slope of 2 to an nth power (where n=−2, −1, 0) with boundaries at a value of 2 to a kth power (where k=−1, 0, 1). The input x and the output y are values in floating-point format. The computer is made to perform operations in multiple segments having different slopes of the broken line with a single computational expression.

### Advantageous Effects of Invention

According to the present disclosure as described above, it is possible to provide a novel and improved computational device, computational method, and computer program capable of computing an accurate approximation of the hyperbolic tangent function with a simple configuration.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an exemplary configuration of the computational device according to an embodiment of the present disclosure.

FIG. 2 is an explanatory diagram illustrating the hyperbolic tangent function and a broken line used to approximate the hyperbolic tangent function.

FIG. 3 is an explanatory diagram illustrating linear expressions for each segment of the broken line approximating the hyperbolic tangent function.

FIG. 4 is an explanatory diagram illustrating a specific circuit configuration example of a computational unit 110.

FIG. 5 is an explanatory diagram illustrating parameters input into the computational unit 110 illustrated in FIG. 4.

FIG. 6 is an explanatory diagram illustrating a circuit configuration of the computational unit 110 that performs an operation of approximating the hyperbolic tangent function with respect to an input in half-precision floating-point format.

FIG. 7 is an explanatory diagram illustrating a circuit configuration example of the computational unit 110.

FIG. 8 is an explanatory diagram illustrating a circuit configuration example of the computational unit 110.

FIG. 9 is an explanatory diagram illustrating a circuit configuration example of the computational unit 110.

FIG. 10 is an explanatory diagram illustrating a circuit configuration example of the computational unit 110.

FIG. 11 is an explanatory diagram illustrating a circuit configuration example of the computational unit 110.

FIG. 12 is an explanatory diagram illustrating an effect caused by using the computational device 100 according to the embodiment.

FIG. 13 is a block diagram illustrating an exemplary hardware configuration of an information processing device according to the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Embodiment of Present Disclosure
1.1. Overview
1.2. Configuration Example
1.3. Operation Example
1.4. Modified Example

2. Hardware Configuration Example

3. Conclusion

### 1. Embodiment of Present Disclosure

### 1.1. Overview

Before describing an embodiment of the present disclosure in detail, an overview of an embodiment of the present disclosure will be described.

As described above, in the field of neural networks, the hyperbolic tangent function (tanh) is used extensively. The hyperbolic tangent function is a nonlinear function, and to simplify the computation of the hyperbolic tangent function, technologies that approximate the hyperbolic tangent function with a linear expression or the like are disclosed in Patent Literature 1 to 3, for example.

As one attempts to approximate the hyperbolic tangent function accurately, operation units of larger circuit scale for polynomial approximation, the square root function, and the like become necessary. The circuit scale also becomes larger in the case of approximating the hyperbolic tangent function by using a lookup table. In cases such as processing hyperbolic tangent function circuits in parallel as the activation function of a neural network, since the circuit scale becomes large, a large degree of parallelization cannot be set.

On the other hand, if the hyperbolic tangent function is approximated roughly by a technique such as 3-segment approximation, the error from the original value of the hyperbolic tangent function becomes larger, and if used as the activation function of a neural network, the errors accumulate, the recognition accuracy falls, and the bias in the error is also large.

Accordingly, in light of the points described above, the author of the present disclosure investigated technologies able to compute an accurate approximation of the hyperbolic tangent function while also keeping the configuration simple. As a result, as described hereinafter, the author of the present disclosure propose a technology capable of computing an accurate approximation of the hyperbolic tangent function while keeping the configuration simple by using bit manipulations and simple bitwise operations.

The above describes an overview of an embodiment of the present disclosure. Next, an embodiment of the present disclosure will be described in detail.

### 1.2. Configuration Example

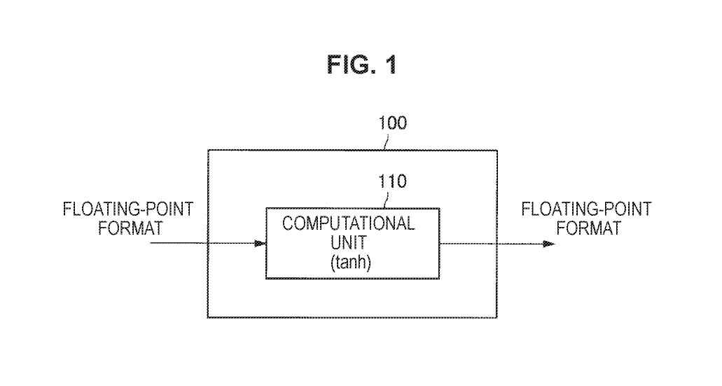

FIG. 1 is an explanatory diagram illustrating an exemplary configuration of the computational device according to an embodiment of the present disclosure. Hereinafter, FIG. 1 will be used to describe an exemplary configuration of the computational device according to an embodiment of the present disclosure.

The computational device 100 according to an embodiment of the present disclosure includes a computational unit 110 that performs the computations of the hyperbolic tangent function (tanh). The computational unit 110 may include a central processing unit (CPU), read-only memory (ROM), random access memory (RAM), and the like.

Data in floating-point format is input into the computational unit 110. The computational unit 110 performs the computations of the hyperbolic tangent function, and outputs data in floating-point format. When performing the computations of the hyperbolic tangent function, the computational unit 110 performs the computations using a broken line that approximates the hyperbolic tangent function according to a predetermined rule. The rule will be described.

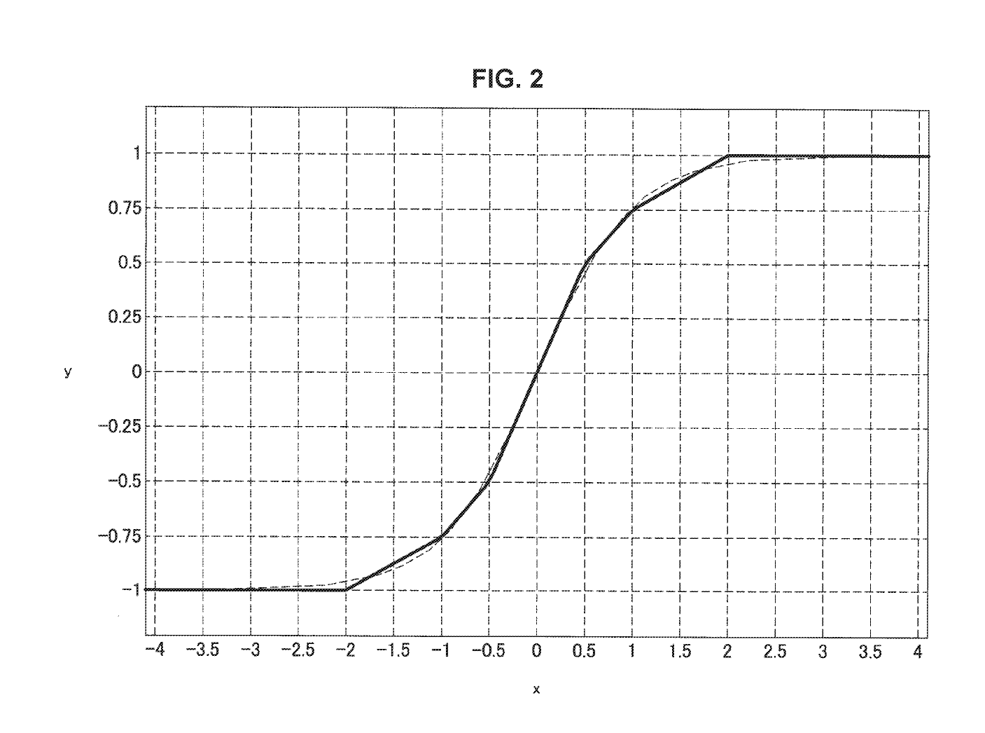

In the present embodiment, the hyperbolic tangent function is approximated by a 7-segment broken line. The slope is the nth power of 2 (where n=−1, 0, 1), and is approximated by an input segment that treats the value of the kth power of 2 (where k=−2, −1, 0) as a boundary. FIG. 2 is an explanatory diagram illustrating the hyperbolic tangent function and the broken line used to approximate the hyperbolic tangent function by the computational unit 110 in the present embodiment.

As illustrated in FIG. 2, in the hyperbolic tangent function, when x is positive y is positive, and when x is negative y is negative. Consequently, the computational unit 110 outputs the same sign y_s as the sign x_s of the input x as the sign of the output y. Note that the sign bit denotes positive as 0 and negative as 1.

The input x has an exponent x_e having a bit width EW. In IEEE 754 format, a denormal number is expressed in the case in which the exponent x_e is 0, infinity or not a number is expressed in the case in which all bits of x_e are 1, and a normal number is expressed otherwise. Also, the input x has a mantissa x_m having a bit width MW. In IEEE 754 format, in the case of a normal number, the 1 of the most significant bit of the original mantissa (the MW+1th bit) is omitted. Note that the maximum exponent value expressed by the exponent is denoted EMAX.

A value expressed in IEEE 754 format is (−1)^{x_s}×2^{x_e-15}×(1+x_m/2¹⁰) in the case of half-precision. (−1)^{x_s}×2^{x_e-127}×(1+x_m/2²³) in the case of single precision, (−1)^{x_s}×2^{x_e-1023}×(1+x_m/2⁵²) in the case of double precision, and (−1)^{x_s}×2^{x_e-16383}×(1+x_m/2¹¹²) in the case of quadruple precision.

Also, as illustrated in FIG. 2, the broken line that the computational unit 110 uses to approximate the hyperbolic tangent function has a slope of 1, or in other words 2⁰, in the segment in which the input x is from −0.5 to 0.5, or in other words from −2⁻¹ to +2⁻¹. Since this segment of the broken line passes through the origin, in the segment in which the input x is from −0.5 to 0.5, or in other words from −2⁻¹ to +2⁻¹, the computational unit 110 outputs the same value as the input x as the output y. By outputting the same value as the input x as the output y, the computational unit 110 is able to support denormal numbers (an exponent of 0) of the IEEE 754 format directly.

Also, in the segment in which the input x is from −1 to −0.5 and from 0.5 to 1, or in other words from −2⁰ to −2⁻¹ and from +2⁻¹ to +2⁰, the slope is 0.5, or in other words 2⁻¹. Also, in the segment in which the input x is from −2 to −1 and from 1 to 2, or in other words from −2¹ to −2⁰ and from +2⁰ to +2¹, the slope is 0.25, or in other words 2⁻². Note that in the case in which the input x is −2 or less, y=−1, and in the case in which the input x is 2 or greater, y=1.

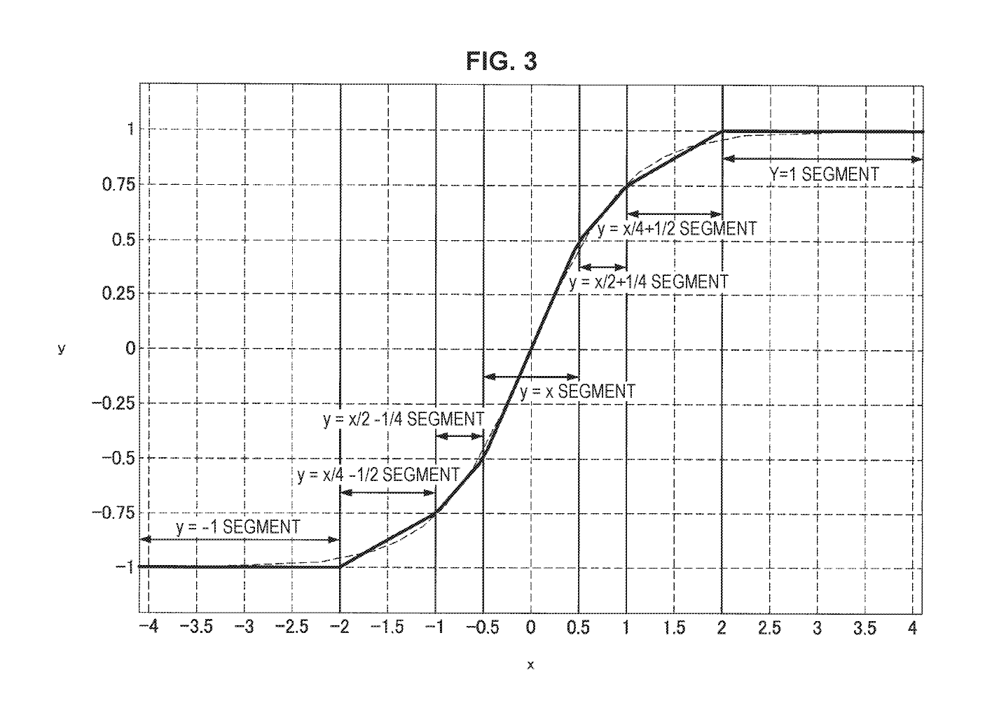

FIG. 3 is an explanatory diagram illustrating linear expressions for each segment of the broken line approximating the hyperbolic tangent function. As described above, in the case in which the input x is −2 or less, y=−1. Also, in the case in which the input x is from −2 to −1, y=x/4−½, in the case in which the input x is from −1 to −0.4, y=x/2−¼, in the case in which the input x is from −0.5 to +0.5, y=x, in the case in which the input x is from +0.5 to +1, y=x/2+¼, and in the case in which the input x is from +1 to +2, y=x/4+½. As described above, in the case in which the input x is +2 or greater, y=1.

Furthermore, a feature of the computational unit 110 according to the present embodiment is to perform the operation of approximating the hyperbolic tangent function not by using arithmetic operation units, but instead by reordering the bits of the input x and using a selector to select the signal to create according to a constant only. In the following description, D[i] denotes the 1-bit numerical value (0 or 1) of the ith bit of the D signal, and D[e:b] denotes the value expressed by the following formula.

Σ_{i=b}^{e}D[i]·2^{i-b} [Math. 2]

Also, the segment of the input x is determined as follows using the exponent x_e of x. If the MSB of the exponent x_e of the input x is 1, the absolute value |x| of the input x is determined to be in the segment in which |x|≥2. Also, if the MSB of the exponent x_e of the input x is 0 and all of the bits between the MSB and the LSB of the exponent x_e of the input x are 1, the absolute value |x| of the input x is determined to be in the segment in which 2>|x|>0.5. Also, if the MSB of the exponent x_e of the input x is 0 and one or more bits set to 0 are included between the MSB and the LSB of the exponent x_e of the input x, the absolute value |x| of the input x is determined to be in the segment in which 0.5>|x|>0.

(1) Case of Segment in which the Absolute Value of the Input x is 2 or Greater

In the case of the segment in which the absolute value of the input x is 2 or greater, y is +1 or −1. Consequently, in this case, the value of the mantissa of the floating-point format data expressing 1 is taken to be the mantissa y_m of the output y, and the value of the exponent of floating-point format data expressing 1 is taken to be the exponent y_e of the output y.

(2) Case of Segment in which the Absolute Value of the Input x is 0.5 or Greater but Less than 2

In the present embodiment, in the segments in which the absolute value of the input x is from 0.5 to 1 and from 1 to 2, the hyperbolic tangent function is approximated by respectively different linear functions, but these two segments can be computed collectively as one.

In the case of the segment in which the absolute value of the input x is 0.5 or greater but less than 2, the least significant bit (LSB) of the exponent x_e of the input x (x_e[0]) is taken to be the most significant bit (MSB) of the mantissa y_m of the output y, and the data concatenating the remaining bit sequence after the removal of the LSB of the mantissa (x_m[0]) of the input x (x_e[0], x_m[MW−1:1]} is taken to be the mantissa y_m of the output y. Also, the value of the exponent of the floating-point format data expressing 0.5 is taken to be the exponent y_e of the output y.

In other words, y_m={x_e[0], x_m[MW−1:1]}, y_e=EMAX−1, and y_s-x_s. Stated differently, x and y can be expressed by the following formulas.

$$x \begin{matrix}= {( - 1 )}^{x \_ s} \cdot {2}^{x \_ e - EMAX} \cdot ( {2}^{MW} + x\_m [ MW - 1 \text{:} 0 ] ) \text{/} {2}^{MW} \\ = {( - 1 )}^{x \_ s} \cdot {2}^{x \_ e - EMAX} \cdot ( 1 + x\_m [ MW - 1 \text{:} 0 ] \text{/} {2}^{MW} )\end{matrix}$$

$$\begin{matrix}y = {( - 1 )}^{y \_ s} \cdot {2}^{y \_ e - EMAX} \cdot ( {2}^{MW} + y\_m [ MW - 1 \text{:} 0 ] ) \text{/} {2}^{MW} \\ = {( - 1 )}^{x \_ s} \cdot {2}^{- 1} \cdot ( {2}^{MW} + x\_e [ 0 ] {2}^{MW - 1} + x\_m [ MW - 1 \text{:} 1 ] ) \text{/} {2}^{MW} \\ = {( - 1 )}^{x \_ s} \cdot ( 1 \text{/} 2 + x\_e [ 0 ] {2}^{- 2} + x\_m [ MW - 1 \text{:} 1 ] {2}^{- 2} \text{/} {2}^{MW - 1} ) \\ = {( - 1 )}^{x \_ s} \cdot ( 1 \text{/} 2 + ( x\_e [ 0 ] + x\_m [ MW - 1 \text{:} 1 ] \text{/} {2}^{MW - 1} ) \text{/} 4 )\end{matrix}$$

In the case in which the exponent x_e of the input x is equal to EMAX(x_e[0]=1), that is, in the segment in which y=x/4±½, x and y can be expressed by the following formulas.

$$x = {( - 1 )}^{x \_ s} \cdot ( 1 + x\_m [ MW - 1 \text{:} 0 ] \text{/} {2}^{MW} )$$

$$\begin{matrix}y = {( - 1 )}^{x \_ s} \cdot ( 1 \text{/} 2 + ( 1 + x\_m [ MW - 1 \text{:} 1 ] \text{/} {2}^{MW - 1} ) \text{/} 4 ) \\ \approx {( - 1 )}^{x \_ s} \cdot ( 1 \text{/} 2 + ( 1 + x\_m [ MW - 1 \text{:} 0 ] \text{/} {2}^{MW - 1} ) \text{/} 4 ) \\ = {( - 1 )}^{x \_ s} \cdot 1 \text{/} 2 + {( - 1 )}^{- x \_ s} \cdot ( 1 + x\_m [ MW - 1 \text{:} 01 ] \text{/} {2}^{MW} ) \text{/} 4 \\ = {( - 1 )}^{x \_ s} \text{/} 2 + x \text{/} 4\end{matrix}$$

Also, in the case in which the exponent x_e of the input x is equal to EMAX(x_e[0]=0), that is, in the segment in which y=x/4±½, x and y can be expressed by the following formulas.

$$\begin{matrix}x = {( - 1 )}^{x \_ s} \cdot {2}^{- 1} \cdot ( 1 + x\_m [ MW - 1 \text{:} 0 ] \text{/} {2}^{MW} ) \\ = {( - 1 )}^{x \_ s} \cdot ( 1 \text{/} 2 + x\_m [ MW - 1 \text{:} 0 ] \text{/} {2}^{MW + 1} )\end{matrix}$$

$$\begin{matrix}y = {( - 1 )}^{x \_ s} \cdot ( 1 \text{/} 2 + ( 0 + x\_m [ MW - 1 \text{:} 1 ] \text{/} {2}^{MW - 1} ) \text{/} 4 ) \\ = {( - 1 )}^{x \_ s} \cdot ( 1 \text{/} 2 + x\_m [ MW - 1 \text{:} 1 ] \text{/} {2}^{MW + 1} ) \\ \approx {( - 1 )}^{x \_ s} \cdot ( 1 \text{/} 2 + x\_m [ MW - 1 \text{:} 0 ] \text{/} {2}^{MW + 1} \text{/} 2 \\ = {( - 1 )}^{x \_ s} \cdot ( 1 \text{/} 4 + ( 1 \text{/} 2 + x\_m ⌈ MW - 1 \text{:} 0 ⌉ \text{/} {2}^{MW + 1} ) \text{/} 2 ) \\ = {( - 1 )}^{x \_ s} \cdot 1 \text{/} 4 + {( - 1 )}^{- x \_ s} \cdot ( 1 \text{/} 2 + x\_m [ MW - 1 \text{:} 0 ] \text{/} {2}^{MW + 1} ) \text{/} 2 \\ = {( - 1 )}^{x \_ s} \text{/} 4 + x \text{/} 2\end{matrix}$$

Consequently, in the segments in which the absolute value of the input x is from 0.5 to 1 and from 1 to 2, the hyperbolic tangent function is approximated by respectively different linear functions, but these two segments can be computed collectively as one.

(3) Case of Segment in which the Absolute Value of the Input x is 0 or Greater but Less than 0.5

In the case of the segment in which the absolute value of the input x is 0 or greater but less than 0.5, the mantissa x_m of the input x is taken to be the mantissa y_m of the output y. In other words, y_m=x_m. Also, the exponent x_e of the input x is taken to be the exponent y_e of the output y. In other words, y_e=x_e. In other words, as described above, in the case of the segment in which the absolute value of the input x is 0 or greater but less than 0.5, the input x is taken to be the output y as-is.

Given the above, the operation of approximating the hyperbolic tangent function by the computational unit 110 expressed in pseudocode is as follows.

```
if(x_e[EW−1]){
        y_e = EMAX
        y_m = 0
}else if(x_e[EW−2] & x_e[EW−3] & ... & x_e[2] & x_e[1]){
        y_e = EMAX−1
        y_m = {x_e[0],x_m[9:1]}
}else{
        y_e = x_e
        y_m = x_m
}
y_s = x_s
```

The branching may also be performed according to the value of the input x rather than a bit determination of the exponent of the input x. The code in this case is as follows.

```
if(x >= 2.0){
        y_e = EMAX
        y_m = 0
}else if(x >= 0.5){
        y_e = EMAX−1
        y_m = {x_e[0],x_m[9:1]}
}else{
        y_e = x_e
        y_m = x_m
}
y_s = x_s
```

In this way, by having the computational unit 110 perform the operation of approximating the hyperbolic tangent function as a linear function in this way, it is possible to compute an accurate approximation of the hyperbolic tangent function while keeping the configuration simple.

Next, a specific circuit configuration example of the computational unit 110 will be described.

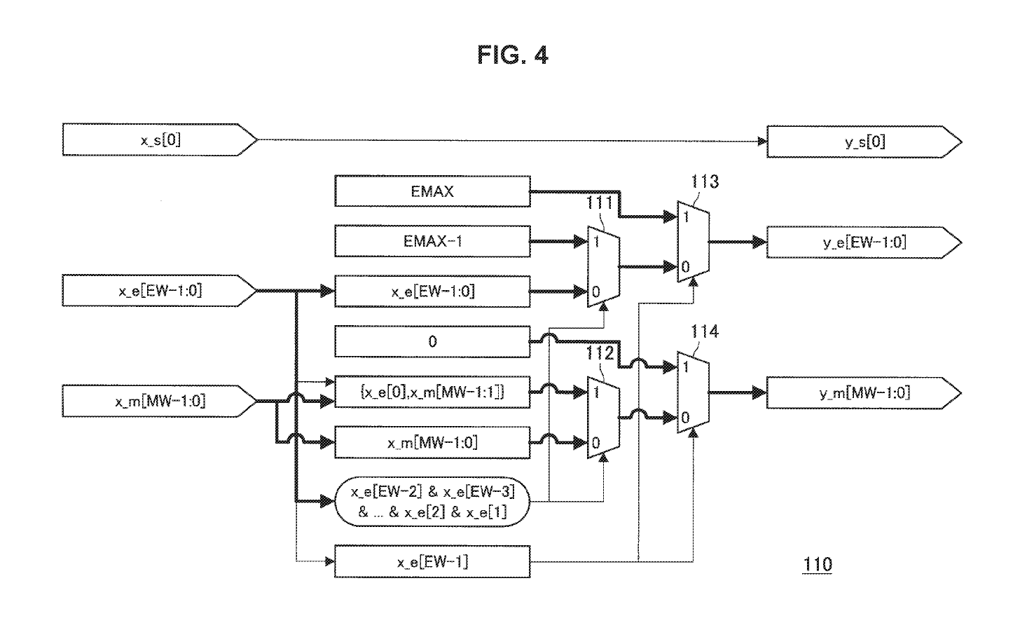

FIG. 4 is an explanatory diagram illustrating a specific circuit configuration example of the computational unit 110. FIG. 4 illustrates a situation in which a sign x_s[0] of the input x, an exponent x_e[EW−1:0] of the input x, and a mantissa x_m[MW−1:0] of the input x are input into the computational unit 110 as the input, and a sign y_s[0] of the output y, an exponent y_e[EW−1:0] of the output y, and a mantissa y_m[MW−1:0] of the output y are output from the computational unit 110 as the output.

As described above, the sign x_s[0] of the input x is directly taken to be the sign y_s[0] of the output y.

A selector 111 is a selector configured to output either the exponent x_e[EW−1:0] of the input x or EMAX−1. The result of a bit determination of the exponent of the input x (x_e[EW−2] & x_e[EW−3] & . . . & x_e[2] & x_e[1]) is input into the selector 111. In the case in which x_e[EW−2] & x_e[EW−3] & . . . & x_e[2] & x_e[1]=1, the selector 111 outputs EMAX−1, and in the case of 0, the selector 111 outputs x_e[EW−1:0].

A selector 112 is a selector configured to output either the bit sequence {x_e[0], x_m[MW−1:1]} or the mantissa x_m[MW−1:0] of the input x. The result of a bit determination of the exponent of the input x (x_e[EW−2] & x_e[EW−3] & . . . & x_e[2] & x_e[1]) is input into the selector 112, similarly to the selector 111. In the case in which x_e[EW−2] & x_e[EW−3] & . . . & x_e[2] & x_e[1]=1, the selector 112 outputs the bit sequence {x_e[0], x_m[MW−1:1]}, and in the case of 0, the selector 112 outputs x_m[MW−1:0].

A selector 113 is a selector configured to output either the parameter EMAX or the output of the selector 111, and treat the output as the exponent y_e[EW−1:0] of the output y. The MSB of the exponent x_e of the input x, namely x_e[EW−1], is input into the selector 113. In the case in which x_e[EW−1]=1, the selector 113 outputs the parameter EMAX, and in the case of 0, the selector 113 outputs the output of the selector 111.

A selector 114 is a selector configured to output either 0 or the output of the selector 112, and treat the output as the mantissa y_m[MW−1:0] of the output y. The MSB of the exponent x_e of the input x, namely x_e[EW−1], is input into the selector 114, similarly to the selector 113. In the case in which x_e[EW−1]=1, the selector 114 outputs 0, and in the case of 1, the selector 113 outputs the output of the selector 113.

In this way, the computational unit 110 includes a block that performs bit manipulations, a block that performs a bitwise OR, and selectors. Consequently, it is demonstrated that the computational unit 110 is able to compute an accurate approximation of the hyperbolic tangent function while also keeping the configuration simple.

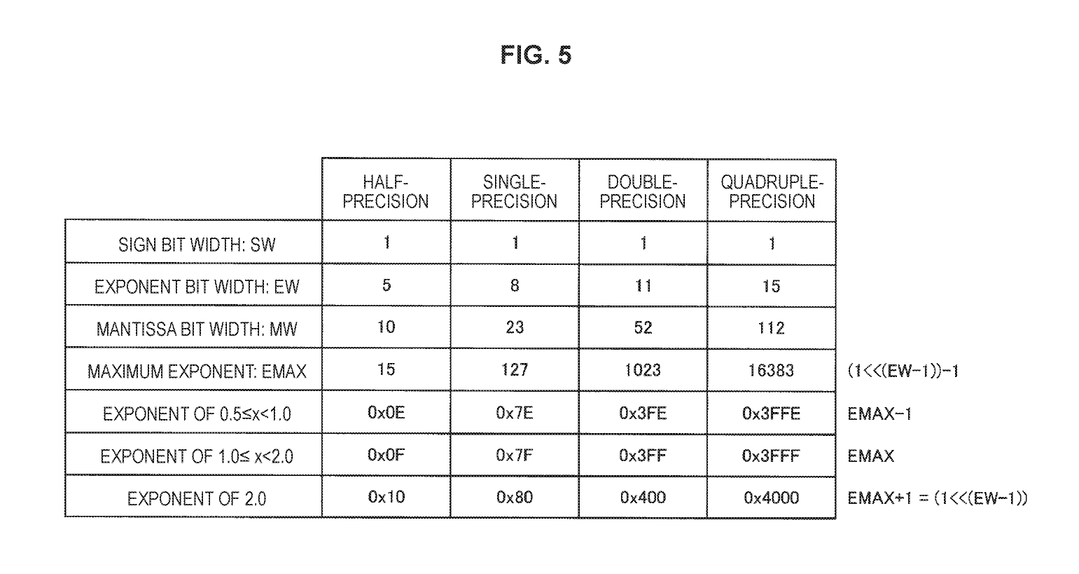

FIG. 5 is an explanatory diagram illustrating parameters input into the computational unit 110 illustrated in FIG. 4. By changing each of the parameters for the cases of half precision, single precision, double precision, and quadruple precision, the computational unit 110 is able to compute an accurate approximation of the hyperbolic tangent function. In the following, a circuit configuration of the computational unit 110 will be illustrated by taking the case of half precision as an example.

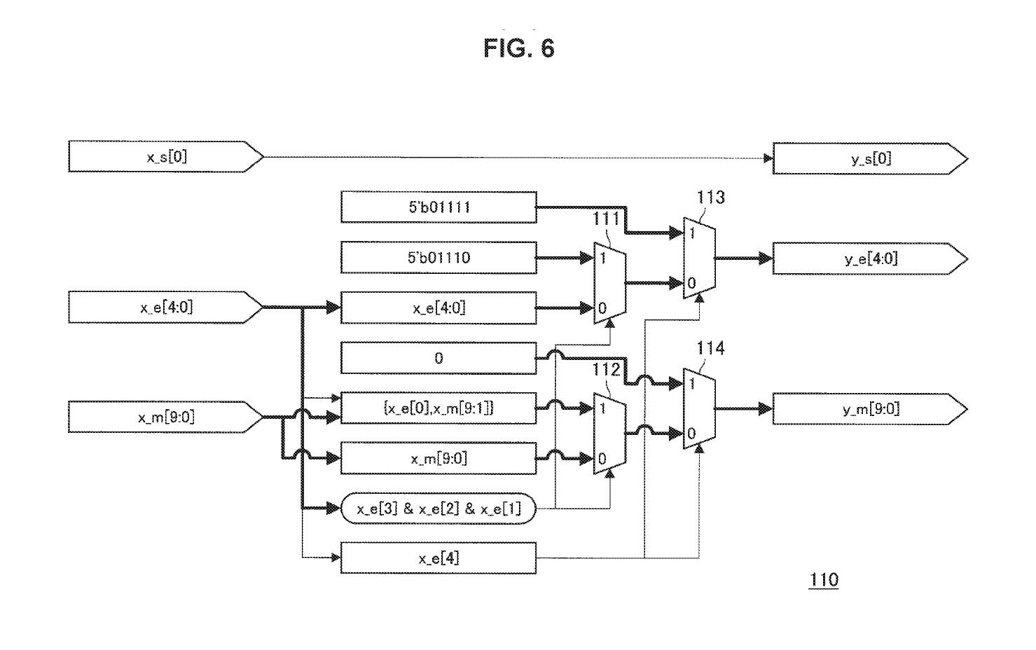

FIG. 6 is an explanatory diagram illustrating a circuit configuration of the computational unit 110 that performs an operation of approximating the hyperbolic tangent function with respect to an input in half-precision floating-point format. As illustrated in FIG. 5, in the case of the half-precision floating-point format, the bit width of the exponent is 5, the bit width MW of the exponent is 15, and the maximum exponent EMAX is 15 (“01111” when expressed in 5 bits). Consequently, applying each of the parameters to the circuit configuration of the computational unit 110 is as illustrated in FIG. 6.

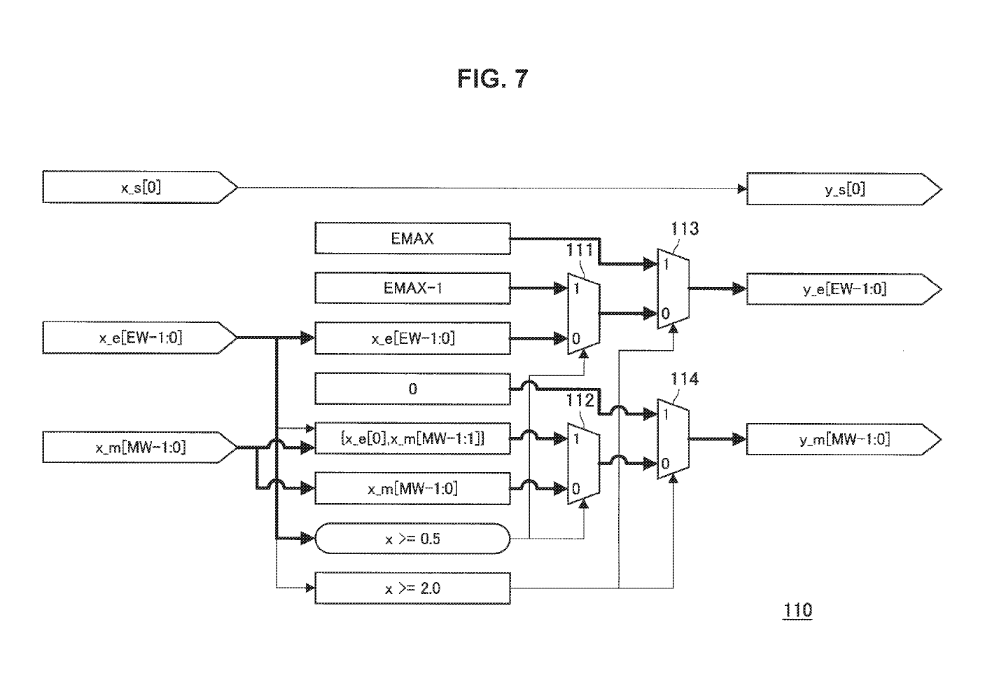

The circuit configuration of the computational unit 110 is not limited to the illustration in FIG. 4. FIGS. 7 to 10 are explanatory diagrams illustrating circuit configuration examples of the computational unit 110.

FIG. 7 is a circuit configuration example of the computational unit 110 for the case in which the branching is performed according to the value of the input x rather than a bit determination of the exponent of the input x. In this case, the selectors 111 and 112 are configured to output “1” if the value of the input x is 0.5 or greater, and to output “0” if less than 0.5. Also, the selectors 113 and 114 are configured to output “1” if the value of the input x is 2 or greater, and to output “0” if less than 2.

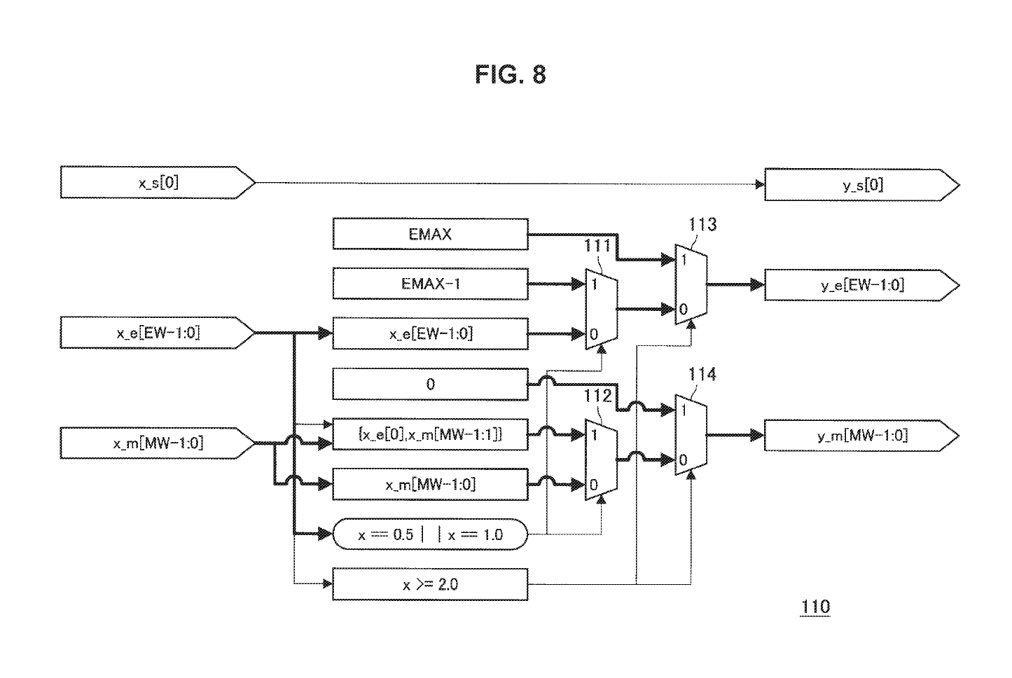

FIG. 8 is a circuit configuration example of the computational unit 110 for the case in which the branching is performed according to the value of the input x rather than a bit determination of the exponent of the input x, similarly to FIG. 7. In this case, the selectors 111 and 112 are configured to output “1” if the value of the input x is 0.5 or greater, and to output “0” if less than 0.5. Also, the selectors 113 and 114 are configured to output “1” if the value of the input x is 2 or greater, and to output “0” if less than 2.

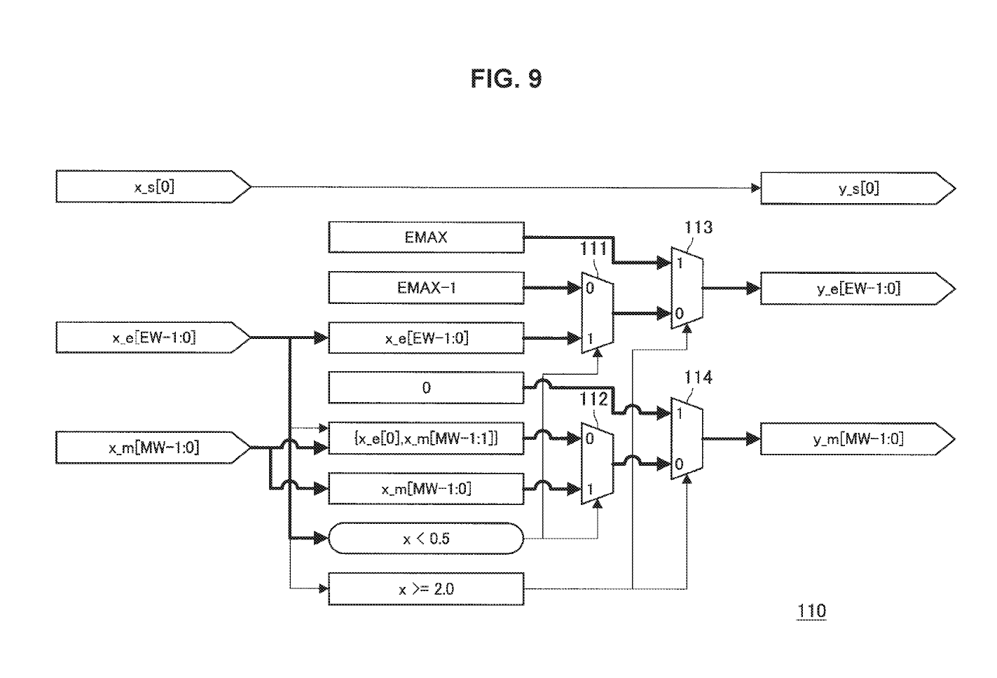

FIG. 9 is a circuit configuration example of the computational unit 110 for the case in which the branching is performed according to the value of the input x rather than a bit determination of the exponent of the input x similarly to FIG. 7, and also in which the outputs of the selectors 111 and 112 are reversed from the circuit in FIG. 7. In other words, the selectors 111 and 112 are configured to output “1” if the value of the input x is less than 0.5, and to output “0” if 0.5 or greater.

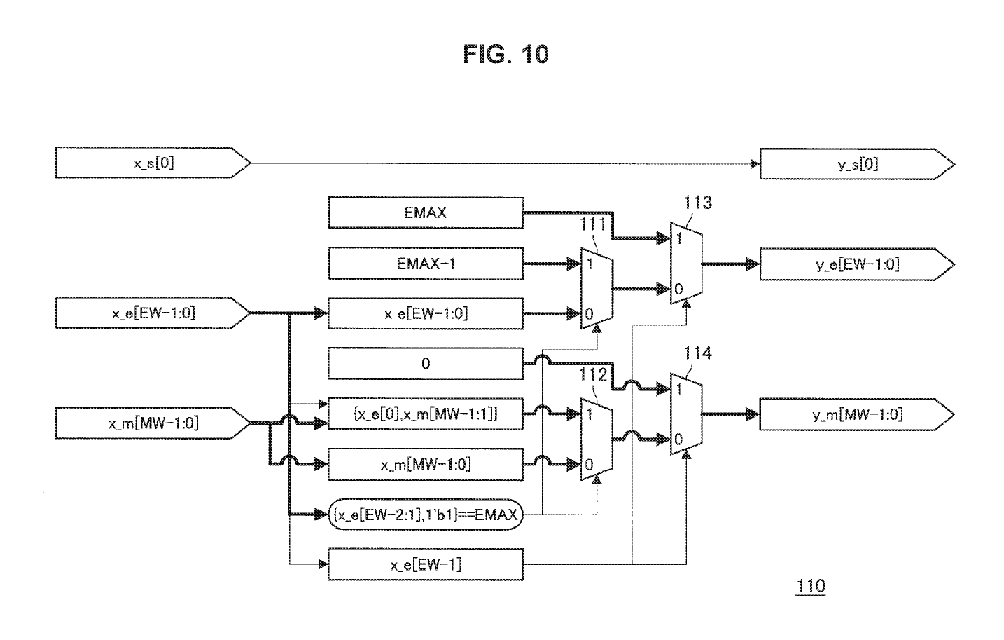

FIG. 10 is a circuit configuration example of the computational unit 110 for the case in which the branching according to whether or not the input x is 0.5 or greater is performed by a different bit determination ({x_e[EW−2:1], 1′b1}==EMAX). The selectors 111 and 112 are configured to output “1” if {x_e[EW−2:1], 1′b1}=EMAX is true, and to output “0” if {x_e[EW−2:1], 1′b1}=EMAX is not true.

Thus far, circuit configuration examples of the computational unit 110 for the case of using 1-bit inputs into the selectors 111 to 114 have been illustrated, but the present disclosure is not limited to such examples. The selector inputs may also be 2-bit.

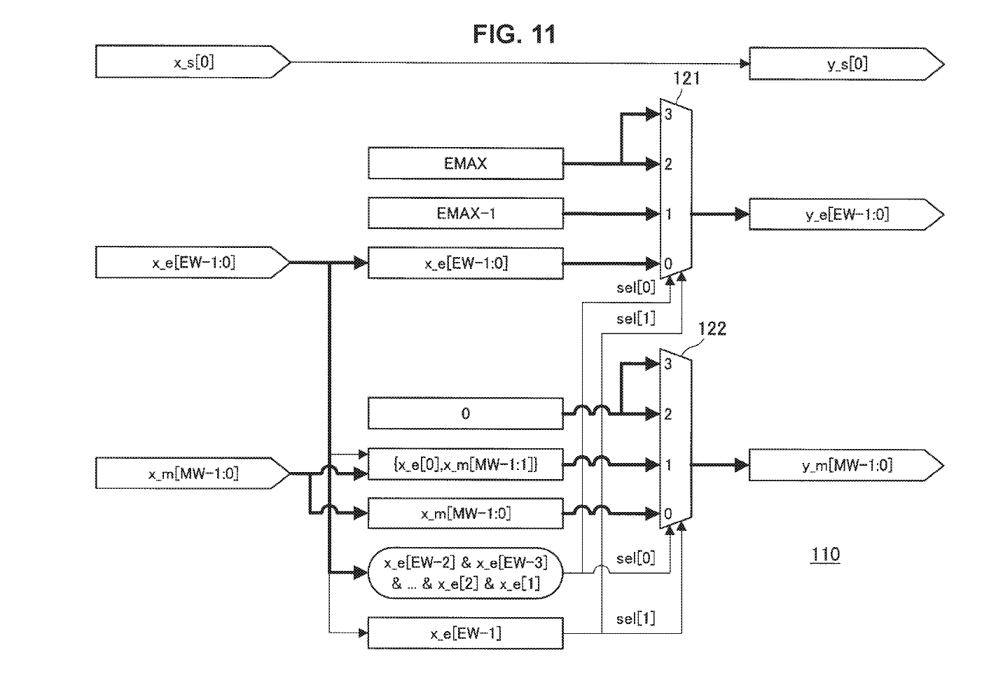

FIG. 11 is an explanatory diagram illustrating a circuit configuration example of the computational unit 110. FIG. 11 illustrates a computational unit 110 provided with selectors 121 and 122 that accept 2-bit inputs.

The selector 121 accepts a 2-bit input whose first bit is the result of a bit determination of the exponent of the input x (x_e[EW−2] & x_e[EW−3] & . . . & x_e[2] & x_e[1]) and whose second bit is the MSB of the exponent x_e of the input x, namely x_e[EW−1], and selects a single output according to the input result. The selector 121 outputs the parameter EMAX in the case in which the second bit (x_e[EW−1]) is 1, and in the case of 0, the selector 121 outputs the parameter EMAX−1 if the first bit (x_e[EW−2] & x_e[EW−3] & . . . & x_e[2] & x_e[1]) is 1, and x_m[MW−1:0] if 0.

Similarly to the selector 121, the selector 122 accepts a 2-bit input whose first bit is the result of a bit determination of the exponent of the input x (x_e[EW−2]& x_e[EW−3] & . . . & x_e[2] & x_e[1]) and whose second bit is the MSB of the exponent x_e of the input x, namely x_e[EW−1], and selects a single output according to the input result. The selector 122 outputs 0 in the case in which the second bit (x_e[EW−1]) is 1, and in the case of 0, the selector 122 outputs the bit sequence {x_e[0], x_m[MW−1:1]} if the first bit (x_e[EW−2] & x_e[EW−3] & . . . & x_e[2] & x_e[1]) is 1, and x_m[MW−1:0] if 0.

In this way, it is demonstrated that by providing the selectors 121 and 122 that accept a 2-bit signal as input and select an output according to the input signal, the computational unit 110 still is able to compute an accurate approximation of the hyperbolic tangent function while keeping a simple configuration provided with a block that performs bit manipulations, a block that performs a bitwise OR, and selectors.

Note that, like the exemplary modifications illustrated in FIGS. 7 to 10 and the like, the configuration of the computational unit 110 illustrated in FIG. 11 obviously may also perform branching according to the value of the input x rather than a bit determination of the exponent of the input x, or interchange the outputs of the selectors 121 and 122.

The format of data input into the computational unit 110 may be one in which the bits of the exponent are inverted for example. In the case in which the bits of the exponent are inverted, in the computational unit 110, the bit determination process for the exponent described above is also inverted.

The format of data input into the computational unit 110 may also be one in which predetermined bits are added to the bits of the exponent in IEEE 754 for example. In this case, in the computational unit 110, support becomes possible by changing the value of the parameter EMAX and varying the range to express. For example, if 2-bit data is added to the exponent in IEEE 754, in the computational unit 110, it is sufficient to add 2 to the parameter EMAX.

In the above description, the data input into the computational unit 110 is taken to be data in floating-point format, but the present disclosure is not limited to such an example. For example, the data input into the computational unit 110 may also be data in fixed-point format. In the case in which data in fixed-point format is input, the computational unit 110 may be provided with a circuit that converts the data in fixed-point format to data in floating-point format.

The computational device 100 according to an embodiment of the present disclosure, by including a block that performs bit manipulations, a block that performs a bitwise OR, and selectors, is able to compute an accurate approximation of the hyperbolic tangent function while keeping the configuration simple. Since the configuration of the computational unit 110 is simple, even if multiple computational units 110 are installed and made to perform parallel processing, for example, increases in the circuit scale of the computational device 100 may be kept small.

In the computational device 100 according to an embodiment of the present disclosure, since the configuration of the computational unit 110 is simple, it is unnecessary to add stages to the pipeline, even in the case of building into the computational unit 110 a module that converts data in fixed-point format to data in floating-point format, for example.

In the computational device 100 according to an embodiment of the present disclosure, a process of normalizing the mantissa in input data in floating-point format is unnecessary. Consequently, a circuit for the normalization process (a count leading zero (CLZ) circuit or shifter circuit) becomes unnecessary.

Because the computational device 100 according to an embodiment of the present disclosure approximates the hyperbolic tangent function with a broken line whose slope changes over seven segments, the accuracy is greatly improved compared to the case of approximating the hyperbolic tangent function with a broken line whose slope changes over fewer segments. Also, the computational device 100 according to an embodiment of the present disclosure has less error bias in the approximation.

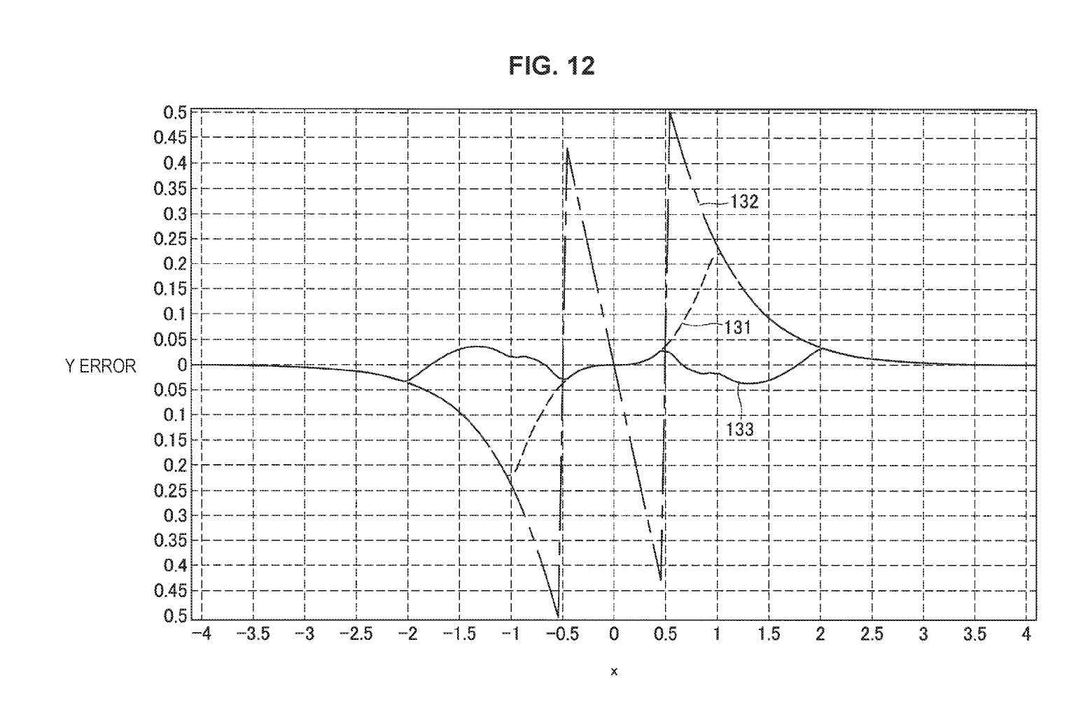

FIG. 12 is an explanatory diagram illustrating an effect caused by using the computational device 100 according to an embodiment of the present disclosure. FIG. 12 illustrates the error in each of a three-segment broken-line approximation, a three-segment step function approximation, and the seven-segment broken-line approximation used by the computational device 100 according to an embodiment of the present disclosure. The sign 131 indicates the error according to the three-segment broken-line approximation, the sign 132 indicates the error according to the three-segment step function approximation, and the sign 133 indicates the error according to the seven-segment broken-line approximation. As illustrated in FIG. 12, in the case of the seven-segment broken-line approximation used by the computational device 100, the error is extremely small compared to the other approximation methods, and since the error that does appear is exhibited both positively and negatively, increases in error due to repeated approximation can be moderated.

The computational device 100X) according to an embodiment of the present disclosure is also able to support denormal numbers (an exponent of 0) of the IEEE 754 format by setting parameters. Additionally, the computational device 100 according to an embodiment of the present disclosure can also be used to compute an approximation of a sigmoid function ((tanh(x/2)+1)/2) using the approximation of the hyperbolic tangent function. In other words, tanh(x/2)/2 can be computed with only an operation of subtracting 1 from the exponents of the input and output of the computational device 100. Consequently, the computational device 100 according to an embodiment of the present disclosure is able to compute a sigmoid function by subtracting 1 from the exponents of the input and output of the computational device 100, and adding ½ to the output result.

### 2. Hardware Configuration Example

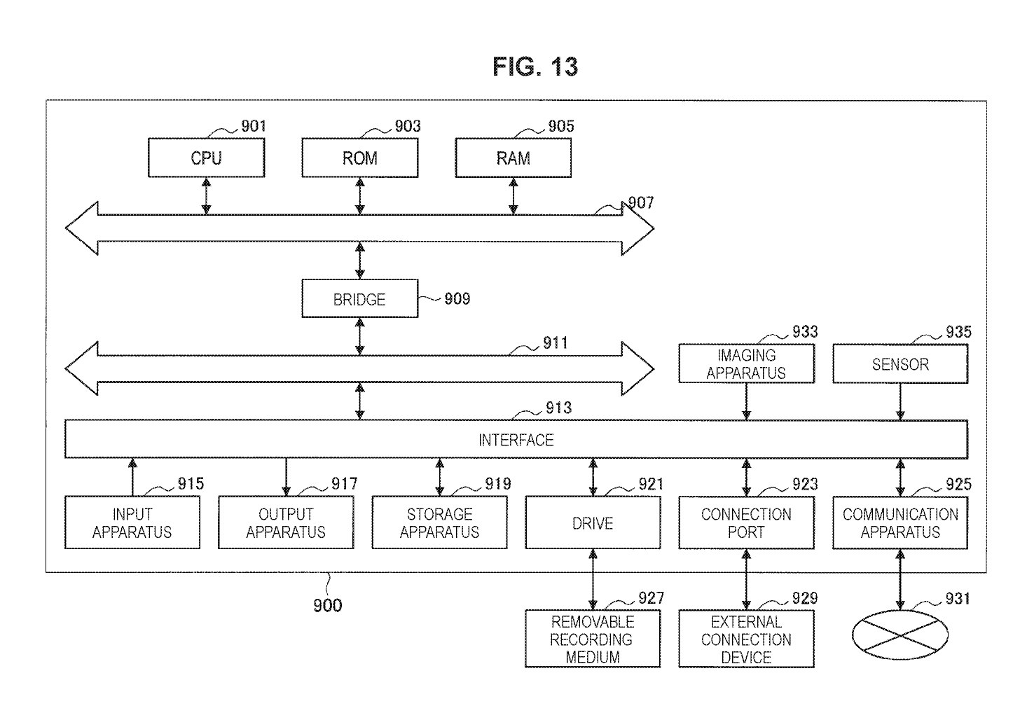

Next, with reference to FIG. 13, a hardware configuration of an information processing apparatus provided with the computational device 100 according to an embodiment of the present disclosure is explained. FIG. 13 is a block diagram illustrating a hardware configuration example of an information processing apparatus according to the embodiment of the present disclosure.

The information processing apparatus 900 includes a central processing unit (CPU) 901, read only memory (ROM) 903, and random access memory (RAM) 905. In addition, the information processing apparatus 900 may include a host bus 907, a bridge 909, an external bus 911, an interface 913, an input apparatus 915, an output apparatus 917, a storage apparatus 919, a drive 921, a connection port 923, and a communication apparatus 925. Moreover, the information processing apparatus 900 may include an imaging apparatus 933, and a sensor 935, as necessary. The information processing apparatus 900 may include a processing circuit such as a digital signal processor (DSP), an application-specific integrated circuit (ASIC), or a field-programmable gate array (FPGA), alternatively or in addition to the CPU 901.

The CPU 901 serves as an arithmetic processing apparatus and a control apparatus, and controls the overall operation or a part of the operation of the information processing apparatus 900 according to various programs recorded in the ROM 903, the RAM 905, the storage apparatus 919, or a removable recording medium 927. The ROM 903 stores programs, operation parameters, and the like used by the CPU 901. The RAM 905 transiently stores programs used when the CPU 901 is executed, and various parameters that change as appropriate when executing such programs. The CPU 901, the ROM 903, and the RAM 905 are connected with each other via the host bus 907 configured from an internal bus such as a CPU bus or the like. Further, the host bus 907 is connected to the external bus 911 such as a Peripheral Component Interconnect/Interface (PCI) bus via the bridge 909.

The input apparatus 915 is an apparatus operated by a user such as a mouse, a keyboard, a touch panel, a button, a switch, and a lever. The input apparatus 915 may be a remote control apparatus that uses, for example, infrared radiation and another type of radio wave. Alternatively, the input apparatus 915 may be an external connection device 929 such as a mobile phone that corresponds to an operation of the information processing apparatus 900. The input apparatus 915 includes an input control circuit that generates input signals on the basis of information which is input by a user to output the generated input signals to the CPU 901. A user inputs various types of data to the information processing apparatus 900 and instructs the information processing apparatus 900 to perform a processing operation by operating the input apparatus 915.

The output apparatus 917 includes an apparatus that can report acquired information to a user visually, audibly, or haptically. The output apparatus 917 may be, for example, a display apparatus such as a liquid crystal display (LCD) or an organic electro-luminescence display, an audio output apparatus such as a speaker or a headphone, or a vibrator. The output apparatus 917 outputs a result obtained through a process performed by the information processing apparatus 900, in the form of video such as text and an image, sounds such as voice and audio sounds, or vibration.

The storage apparatus 919 is an apparatus for data storage that is an example of a storage unit of the information processing apparatus 900. The storage apparatus 919 includes, for example, a magnetic storage device such as a hard disk drive (HDD), a semiconductor storage device, an optical storage device, or a magneto-optical storage device. The storage apparatus 919 stores therein the programs and various data executed by the CPU 901, various data acquired from an outside, and the like.

The drive 921 is a reader/writer for the removable recording medium 927 such as a magnetic disk, an optical disc, a magneto-optical disk, and a semiconductor memory, and built in or externally attached to the information processing apparatus 900. The drive 921 reads out information recorded on the mounted removable recording medium 927, and outputs the information to the RAM 905. Further, the drive 921 writes the record into the mounted removable recording medium 927.

The connection port 923 is a port used to connect devices to the information processing apparatus 900. The connection port 923 may include a Universal Serial Bus (USB) port, an IEEE1394 port, and a Small Computer System Interface (SCSI) port. The connection port 923 may further include an RS-232C port, an optical audio terminal, a High-Definition Multimedia Interface (HDMI) (registered trademark) port, and so on. The connection of the external connection device 929 to the connection port 923 makes it possible to exchange various data between the information processing apparatus 900 and the external connection device 929.

The communication apparatus 925 is a communication interface including, for example, a communication device for connection to a communication network 931. The communication apparatus 925 may be, for example, a communication card for a local area network (LAN), Bluetooth (registered trademark), Wi-Fi, or a wireless USB (WUSB). The communication apparatus 925 may also be, for example, a router for optical communication, a router for asymmetric digital subscriber line (ADSL), or a modem for various types of communication. For example, the communication apparatus 925 transmits and receives signals in the Internet or transits signals to and receives signals from another communication device by using a predetermined protocol such as TCP/IP. The communication network 931 to which the communication apparatus 925 connects is a network established through wired or wireless connection. The communication network 931 may include, for example, the Internet, a home LAN, infrared communication, radio communication, or satellite communication.

The imaging apparatus 933 is an apparatus that captures an image of a real space by using an image sensor such as a charge coupled device (CCD) and a complementary metal oxide semiconductor (CMOS), and various members such as a lens for controlling image formation of a subject image onto the image sensor, and generates the captured image. The imaging apparatus 933 may capture a still image or a moving image.

The sensor 935 is various sensors such as an acceleration sensor, an angular velocity sensor, a geomagnetic sensor, an illuminance sensor, a temperature sensor, a barometric sensor, and a sound sensor (microphone). The sensor 935 acquires information regarding a state of the information processing apparatus 900 such as a posture of a housing of the information processing apparatus 900, and information regarding an environment surrounding the information processing apparatus 900 such as luminous intensity and noise around the information processing apparatus 900. The sensor 935 may include a GPS receiver that receives global positioning system (GPS) signals to measure latitude, longitude, and altitude of the apparatus.

An example of a hardware configuration of the information processing apparatus 900 has been illustrated above. Note that a hardware configuration of the information processing apparatus 900 can be appropriately changed in accordance with a technology level in each implementation.

### 3. Conclusion

As described above, according to an embodiment of the present disclosure, there is provided a computational device 100 capable of computing an accurate approximation of the hyperbolic tangent function while keeping the configuration simple.

The computational device 100 according to an embodiment of the present disclosure is able to compute an accurate approximation of the hyperbolic tangent function while keeping the configuration simple, and thus may be utilized widely in the field of neural networks where the hyperbolic tangent function is used extensively, for example.

A computer program for causing hardware such as a CPU, a ROM, and a RAM that is incorporated in each apparatus, to execute a function equivalent to the above-described configuration of each apparatus can also be created. In addition, a storage medium storing the computer program can also be provided. In addition, by forming each functional block illustrated in a functional block diagram, by hardware, a series of processes can also be implemented by hardware.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A computational device including:

a computational unit configured to approximate a hyperbolic tangent function, which takes a hyperbolic tangent of an input x and outputs an output y, with a broken line having a slope of 2 to an nth power (where n=−2, −1, 0) in which the slope changes on a boundary at which a value of the input x becomes ±2 to a kth power (where k=−1, 0, 1), in which

the input x and the output y are values in floating-point format, and

the computational unit performs operations in multiple segments having different slopes of the broken line with a single computational expression.

(2)

The computational device according to (1), in which

the computational unit generates the output y using bitwise operations and bit reordering with respect to the input x, and a constant.

(3)

The computational device according to (1) or (2), in which

the computational unit performs operations in the segments for values of k from −1 to 1 with a single computational expression.

(4)

The computational device according to any of (1) to (3), in which

the computational unit is provided with a first selector configured to output one of an exponent of the input x and a maximum exponent of the input x on the basis of a result of a predetermined bitwise operation on the exponent of the input x.

(5)

The computational device according to (4), in which

the computational unit is provided with a second selector configured to output one of a value obtained by subtracted 1 from a maximum exponent of the input x and the output of the first selector on the basis of a value of a most significant bit of the exponent.

(6)

The computational device according to any of (1) to (5), in which

the computational unit is provided with a third selector configured to output one of a mantissa of the input x and data concatenating a bit sequence excluding a least significant bit of the mantissa of the input x to the least significant bit of the exponent of the input x on the basis of a result of a predetermined bitwise operation on the exponent of the input x.

(7)

The computational device according to (6), in which

the computational unit is provided with a fourth selector configured to output one of 0 and the output of the third selector on the basis of a value of a most significant bit of the exponent.

(8)

The computational device according to any of (1) to (3), in which

the computational unit is provided with a first selector configured to output one of an exponent of the input x, a maximum exponent of the input x, and a value obtained by subtracting 1 from the maximum exponent of the input x on the basis of a result of a predetermined bitwise operation on the exponent of the input x and a value of a most significant bit of the exponent of the input x.

(9)

The computational device according to (8), in which

the computational unit is provided with a second selector configured to output one of 0, a mantissa of the input x, and data concatenating a bit sequence excluding a least significant bit of the mantissa of the input x to the least significant bit of the exponent of the input x on the basis of a result of a predetermined bitwise operation on the exponent of the input x and a value of a most significant bit of the exponent of the input x.

(10)

A computational method including, by a processor:

approximating a hyperbolic tangent function, which takes a hyperbolic tangent of an input x and outputs an output y, with a broken line having a slope of 2 to an nth power (where n=−2, −1, 0) with boundaries at a value of 2 to a kth power (where k=−1, 0, 1), in which

the input x and the output y are values in floating-point format, and

the processor performs operations in multiple segments having different slopes of the broken line with a single computational expression.

(11)

A computer program causing a computer to

approximate a hyperbolic tangent function, which takes a hyperbolic tangent of an input x and outputs an output y, with a broken line having a slope of 2 to an nth power (where n=−2, −1, 0) with boundaries at a value of 2 to a kth power (where k=−1, 0, 1), in which

the input x and the output y are values in floating-point format, and

the computer is made to perform operations in multiple segments having different slopes of the broken line with a single computational expression.

### REFERENCE SIGNS LIST

100 computational device
111, 112, 113, 114, 121, 122 selector

1. A computational device comprising:
a computational unit configured to approximate a hyperbolic tangent function, which takes a hyperbolic tangent of an input x and outputs an output y, with a broken line having a slope of 2 to an nth power (where n=−2, −1, 0) in which the slope changes on a boundary at which a value of the input x becomes ±2 to a kth power (where k=−1, 0, 1), wherein
the input x and the output y are values in floating-point format, and
the computational unit performs operations in multiple segments having different slopes of the broken line with a single computational expression.

2. The computational device according to claim 1, wherein
the computational unit generates the output y using bitwise operations and bit reordering with respect to the input x, and a constant.

3. The computational device according to claim 1, wherein
the computational unit performs operations in the segments for values of k from −1 to 1 with a single computational expression.

4. The computational device according to claim 1, wherein
the computational unit is provided with a first selector configured to output one of an exponent of the input x and a maximum exponent of the input x on a basis of a result of a predetermined bitwise operation on the exponent of the input x.

5. The computational device according to claim 1, wherein
the computational unit is provided with a second selector configured to output one of a value obtained by subtracted 1 from a maximum exponent of the input x and the output of the first selector on a basis of a value of a most significant bit of the exponent.

6. The computational device according to claim 1, wherein
the computational unit is provided with a third selector configured to output one of a mantissa of the input x and data concatenating a bit sequence excluding a least significant bit of the mantissa of the input x to the least significant bit of the exponent of the input x on a basis of a result of a predetermined bitwise operation on the exponent of the input x.

7. The computational device according to claim 6, wherein
the computational unit is provided with a fourth selector configured to output one of 0 and the output of the third selector on a basis of a value of a most significant bit of the exponent.

8. The computational device according to claim 1, wherein
the computational unit is provided with a first selector configured to output one of an exponent of the input x, a maximum exponent of the input x, and a value obtained by subtracting 1 from the maximum exponent of the input x on a basis of a result of a predetermined bitwise operation on the exponent of the input x and a value of a most significant bit of the exponent of the input x.

9. The computational device according to claim 8, wherein
the computational unit is provided with a second selector configured to output one of 0, a mantissa of the input x, and data concatenating a bit sequence excluding a least significant bit of the mantissa of the input x to the least significant bit of the exponent of the input x on a basis of a result of a predetermined bitwise operation on the exponent of the input x and a value of a most significant bit of the exponent of the input x.

10. A computational method comprising, by a processor:
approximating a hyperbolic tangent function, which takes a hyperbolic tangent of an input x and outputs an output y, with a broken line having a slope of 2 to an nth power (where n=−2, −1, 0) with boundaries at a value of 2 to a kth power (where k=−1, 0, 1), wherein
the input x and the output y are values in floating-point format, and
the processor performs operations in multiple segments having different slopes of the broken line with a single computational expression.

11. A computer program causing a computer to
approximate a hyperbolic tangent function, which takes a hyperbolic tangent of an input x and outputs an output y, with a broken line having a slope of 2 to an nth power (where n=−2, −1, 0) with boundaries at a value of 2 to a kth power (where k=−1, 0, 1), wherein
the input x and the output y are values in floating-point format, and
the computer is made to perform operations in multiple segments having different slopes of the broken line with a single computational expression.
